(19) United States
(12) Patent Application Publication
(10) Pub. No.: US 2007/0264528 A1
(43) Pub. Date: Nov. 15, 2007

(54) Modeling compound and articles created using same

(76) Inventor: Elaine M. Knight, Aptos, CA (US)

Correspondence Address: MICHAEL A. GUTH, 2-2905 EAST CLIFF DRIVE, SANTA CRUZ, CA, 95062, US

(21) Appl. No.: 11/431,218

(22) Filed: May 9, 2006

(51) Int. Cl. B05D 1/36; B32B 9/00

(52) U.S. Cl. 428/702; 106/803; 106/805; 106/811; 427/402

(57) ABSTRACT

A clay based modeling compound comprising clay, pulp, and other constituents that will reach its desired final condition without firing. A method of making works of art and of adding texture and other features to works of art using a clay based modeling compound comprising clay, pulp, and other constituents.

### BACKGROUND

1. Field of the Invention

This invention relates to modeling compound, and more specifically to a clay mixture and articles created using the mixture.

2. Description of Related Art

Clay may be used as modeling compound. Classification of clay into categories can be based upon the fired density of the finished product. For example, term such as “porcelain”, “stoneware”, and “earthenware” typically refer to the density or porosity of the finished works. Clay of the types mentioned above is fired in a kiln at various temperatures with a typical range of temperatures 1300 to 2100 degrees Fahrenheit.

Another modeling compound consists of paper clay composites. Paperclay is clay to which paper fiber has been added. Compared to traditional clay, paperclay cracks less often and also can be repaired prior to firing. An example of a method of preparing a ceramic mixture from paper and clay suitable for ceramic firing is seen in U.S. Pat. No. 5,726,111 to Gault.

Fired clay and paper clay articles, and compositions that require firing to reach their desired end properties, carry a drawback that they cannot be added to other mediums in a composite work prior to firing if the other materials cannot withstand the firing temperature. For example, some artists wish to combine sculpting and painting at the same time. The compound according to this invention allows the artist to add dimension to their works of art. In addition, there are many users who do not want to fire their product at all, such as artists who create works on canvas and other substrates. An example would be a class of schoolchildren creating art projects who want to create works but do not have access to a kiln.

Some clay like air dry products do exist on the market. Typically, these products include some plastic resin base. The polymer or PVC type product added to the compound makes the compound less pliable, much more difficult to finely sculpt, and usually will not accept water. If water is added to such compounds, they will typically be prone to cracking. Some bakable (as opposed to fired) products exist but carry similar drawbacks to the plastic added products, as well as the drawback that many substrates are not heat resistant at all.

What is called for is a clay based modeling compound that is light and easy to work with, and also does not need to be fired to reach a desired finished and hard condition. What is also called for is a clay based modeling compound that is pliable and to which water may be added while utilizing the compound, and that can be applied to canvas and other substrates, to wooden furniture, to sheetrock walls, to straw bale walls, to stucco walls, to cob walls, and other substrates to create multi-dimensional artworks, and that can be sculpted into free standing objects, and has minimal cracking.

Such a material creates a significant improvement in the entire art field. An artist has been previously limited to a relatively flat canvas on which to paint. A representational artist now can bridge the gap between two-dimensional and three-dimensional works, and can create sculpted works beginning with a flat canvas.

### SUMMARY

A clay based modeling compound comprising clay, pulp, and other constituents that has great pliability and that will reach its desired final condition without firing. A method of making works of art and of adding texture and other features to works of art using a clay based modeling compound comprising clay, pulp, and other constituents.

### BRIEF DESCRIPTION OF THE DRAWINGS

FIG. 1 is a photograph of a free standing artwork according to some embodiments of the present invention.

FIG. 2 is a photograph of an artwork according to some embodiments of the present invention.

FIG. 3 is a photograph of an artwork according to some embodiments of the present invention.

FIG. 4 is a photograph of a canvas substrate with adhesive according to some embodiments of the present invention.

FIG. 5 is a photograph of a canvas substrate with adhesive according to some embodiments of the present invention.

FIG. 6 is a photograph of modeling compound applied to a canvas substrate according to some embodiments of the present invention.

FIG. 7 is a photograph of modeling compound applied to a wood substrate according to some embodiments of the present invention.

FIG. 8 is a photograph of a cloth strip ready to be adhered to modeling compound according to some embodiments of the present invention.

FIG. 9 is a photograph of a cloth strip adhered to modeling compound according to some embodiments of the present invention.

FIG. 10 is a photograph of an object being readied to be adhered to modeling compound according to some embodiments of the present invention.

FIG. 11 is a photograph of an object being adhered to modeling compound according to some embodiments of the present invention.

FIG. 12 is a photograph of objects being readied to be adhered to modeling compound according to some embodiments of the present invention.

FIG. 13 is a photograph of objects being adhered to modeling compound according to some embodiments of the present invention.

FIG. 14 is a photograph of a work on a wall according to some embodiments of the present invention.

FIG. 15 is a photograph of a sculpture on canvas according to some embodiments of the present invention.

FIGS. 16-17 are photographs of an artwork created on a table according to some embodiments of the present invention.

### DETAILED DESCRIPTION

In some embodiments of the present invention, a modeling compound is prepared out of clay, pulp, and wallpaper paste. The resulting compound is an excellent material for modeling, similar to standard clays, with a significant improvement in it's increased pliability, increased adhesion properties, and in that the compound may achieve significant hardness when air dried with minimal cracking and does not need to be fired. In addition, the compound may be used to create artworks in a way not previously possible with fired clays.

A prepared wet clay may be used, or dry clay ingredients may be used to which water is added to form the clay body prior to adding the other ingredients of the compound.

The pulp used in the mixture is paper pulp in some embodiments. The paper pulp may be prepared from recycled newspaper or recycled non-coated white office paper, for example. A preferred paper tears easily and breaks down in water easily. The paper pulp may be obtained in thick sheets (cardboard like) from recycled paper processors who recycle white office paper and newspaper, and who use a non-chlorine de-inking process, which is a more environmentally friendly way of preparing paper pulp. Pulp may also be purchased on the market as either a new or recycled product. Pulp typically is pulp of wood or other fibrous cellulosic material, although it may be derived from rice, hemp, and other plants. Although paper is typically made from pulp, paper is not a requirement of the compound according to this invention. The less processed pulp may be used. Pulp is available in sheets and in other forms.

The sheets of pulp may be wetted with water, use minimal water sufficient to fully dampen the sheets. Dry wheat wallpaper paste is then sprinkled on the sheets of dampened paper pulp. Dry wheat wallpaper paste may consist of common wheat flour. The common wheat flour Triticum vulgare (sativum) is a frequently used flour for making wallpaper paste.

The sheets of dampened pulp with the wallpaper paste may then be added to the clay and mixed with the wet clay in an industrial mixer-pugger machine for as much time as needed to achieve a uniform mixing of the pulp, wallpaper paste, and clay, and until the fibers of the pulp are broken down into a very fine mixture. Small amounts of water are gradually added to the mixture as needed during the mixing process to achieve the desired consistency. A non-toxic enzyme based preservative, or a chemical such as chlorine is added to the mixture to prevent spoilage of the compound in some embodiments. In some embodiments, the compound may be kneaded by hand or with other devices.

An example of the relative constituencies of the components of the compound is as follows. The clay and the moistened paper pulp are mixed in approximately a 25 pounds to 1.75-2.5 pounds ratio, respectively. Two to three tablespoons of wallpaper paste per pound of clay is used. In some embodiments, such as when the compound is used more as a interior finish, such as with straw bale walls, as opposed to modeling, there may be more pulp added. In such a case, the ration may be 25 pounds of clay to 7 pounds of pulp. The above-described compounds will have the benefits of the properties described below.

The addition of the wallpaper paste to the paperclay composite gives the modeling compound superior strength. The modeling compound will adhere to other objects in a fashion not achievable by clay and paperclay without the wallpaper paste. The modeling compound is also much less likely to crack while drying than clay or paperclay. The modeling compound air dries to a stone hardness.

A modeling compound according to some embodiments of the present invention may be easily used by children, and also by adults who are not wanting to fire their works. Also, without the need to fire the work, the modeling compound may be used in conjunction with other items in the creation of a work or an artwork, items which themselves would not be able to withstand the heat of firing.

The modeling compound may be painted on wet or dry, and does not need to utilize a glaze which is fired along with traditional clay works. In addition, many, if not all works utilizing fired clays do not accept paints well after firing. The modeling compound can be adhered to a substrate, and will adhere well to a substrate. For example, a wood or canvas substrate may have the modeling compound adhered to portions of or the entire substrate, creating a three dimensional substrate on which an artist can create a painted work, or allowing the artist to sculpt objects directly on the substrate. In addition, other items can be inserted into or adhered to the modeling compound that has already been adhered to a substrate. This process can occur before the modeling compound has air dried, and then the modeling compound will dry to a very hard level. The texture created by the paper fibers in the compound accept paint in a unique way to create shading effects in the painting.

The modeling compound can also be sculpted or shaped into free standing, or stand alone, objects, into which objects may be embedded. With the advantage of not being prone to cracking while drying, and of drying to a stone like hardness, the modeling compound allows an artist to create a free standing, permanent, sculpture that previously could only be created with a fired product.

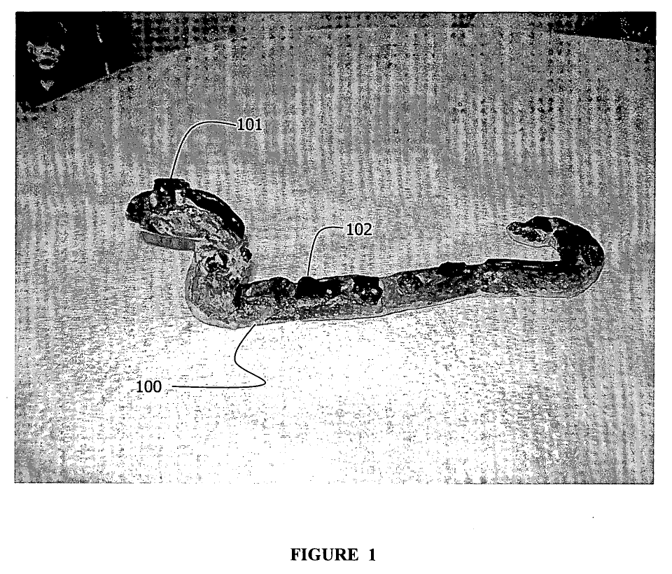

FIG. 1 illustrates an artwork 100 according to some embodiments of the present invention. The artwork 100, an artist's version of a snake, was created out of a modeling compound according to some embodiments of the present invention. The artwork 100 was air dried and is very hard. In addition, the artwork 100 did not crack while drying. Some small objects 101, 102 may be seen embedded in the artwork. These small objects were embedded in the modeling compound prior to the drying of the compound and are firmly attached.

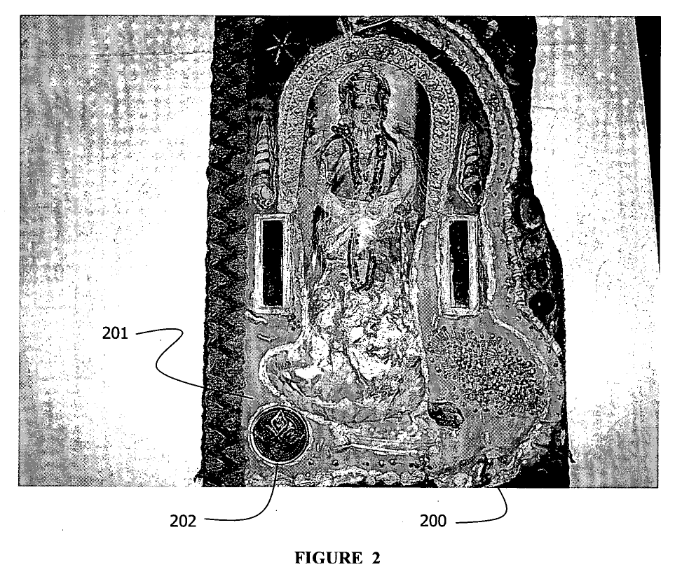

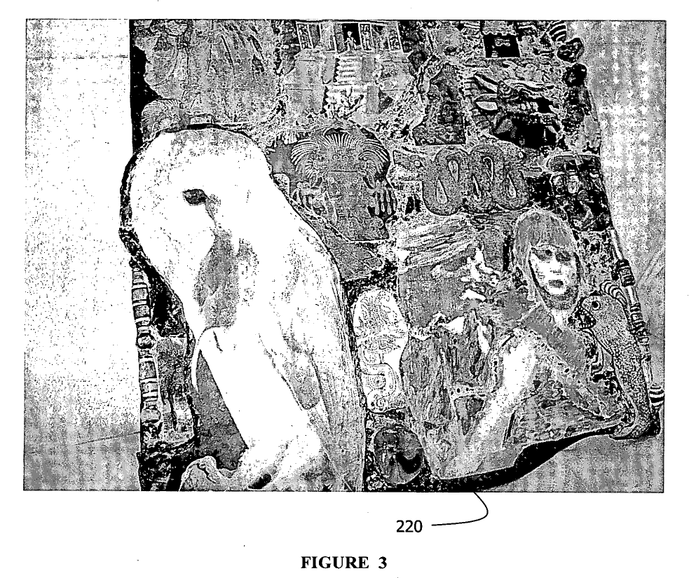

FIGS. 2 and 3 illustrate artwork 200, 220 according to some embodiments of the present invention. As seen in FIG. 2, an artwork 200 is richly textured when created according to some embodiments of the present invention. The use of modeling compound 201 over a substrate allows for a three dimensional effect to be created, as well as for the attachment of additional objects, such as the disc 202 seen in the lower left corner. As seen in FIG. 3, an artwork 220 is also richly textured.

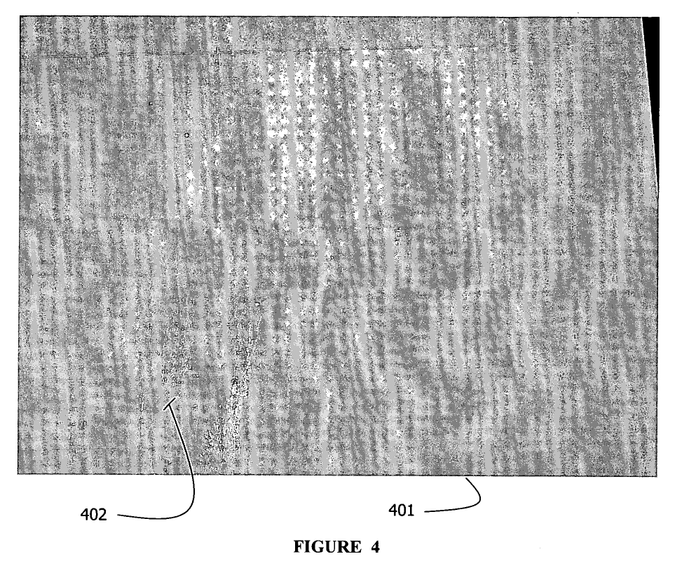

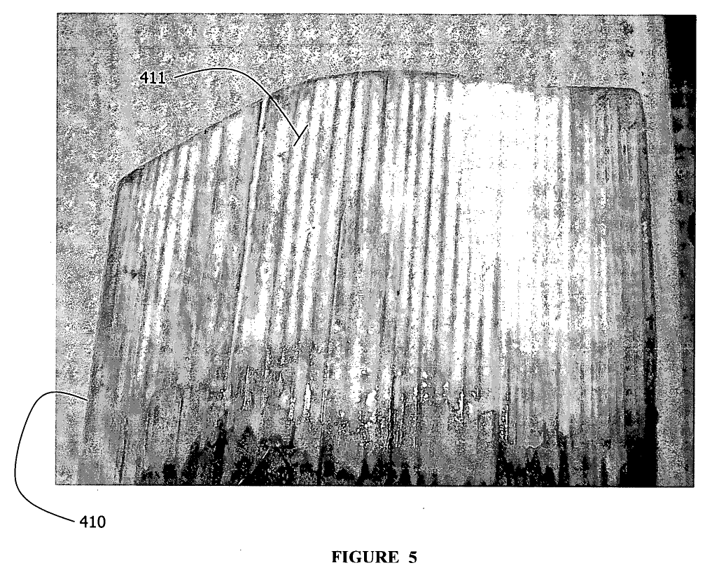

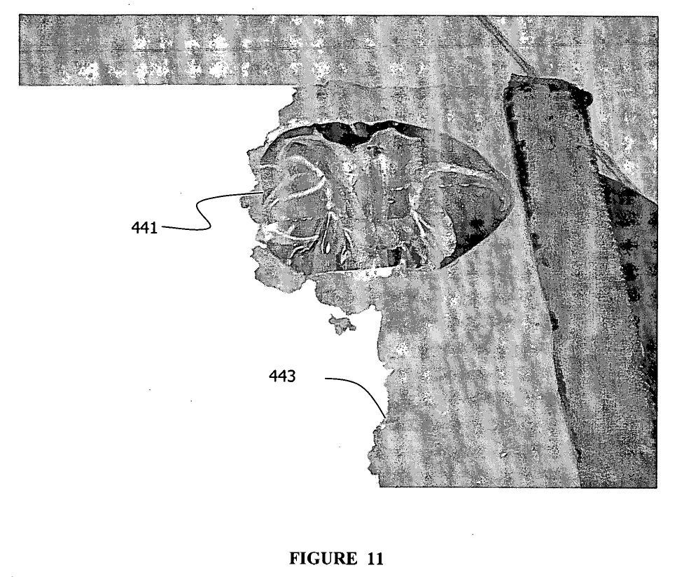

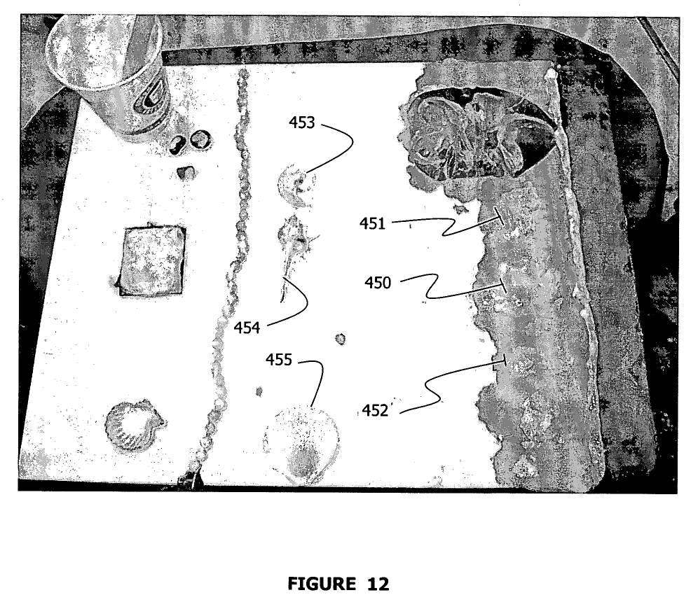

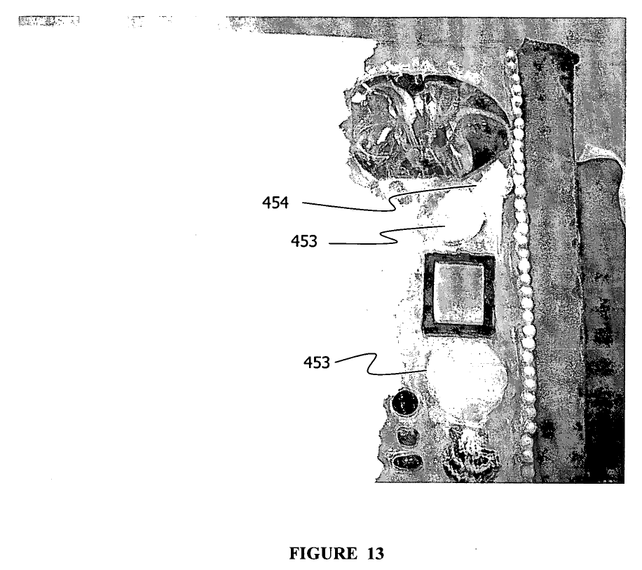

FIGS. 4-13 illustrate the process of creating an artwork according to some embodiments of the present invention. FIGS. 4 and 5 illustrate substrates being prepared for the addition a modeling compound with a layer of adhesive. In some embodiments, the adhesive is common white glue. A canvas substrate 401 is covered with adhesive layer 402 in the area in which the artist wishes to adhere modeling compound. A wood substrate 410 is covered with adhesive layer 411 in the area in which the artist wishes to adhere modeling compound. A variety of substrates may be used. For example, canvas, wood, cardboard, metal cloth, and even previously fired ceramics may be used as a substrate.

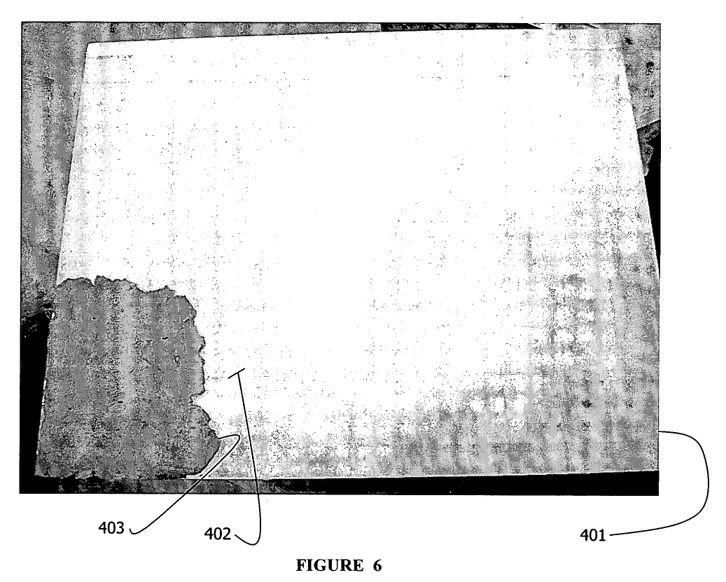

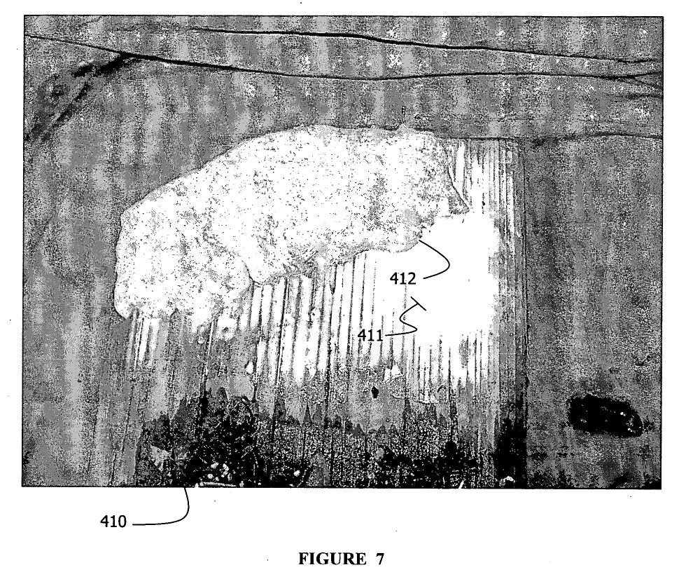

FIGS. 6 and 7 illustrate substrate having modeling compound applied over the adhesive layer according to some embodiments of the present invention. As seen in FIG. 6, a canvas substrate 401 has been partially covered with an adhesive layer 402. The modeling compound 403 is applied over the adhesive layer 402. After drying, the modeling compound 403 will be very hard, with minimal or no cracks. The modeling compound 403 will be well adhered to the substrate 401. As seen in FIG. 7, a wood substrate 410 has been partially covered with an adhesive layer 411. The modeling compound 412 is applied over the adhesive layer 411. After drying, the modeling compound 412 will be very hard, with minimal or no cracks. The modeling compound 412 will be well adhered to the substrate 410. The addition of the wallpaper paste and the pulp to the clay results in significantly improved adhesion to these substrates. The resulting work is capable of being produced with texture and sculpted with a three dimensional aspect.

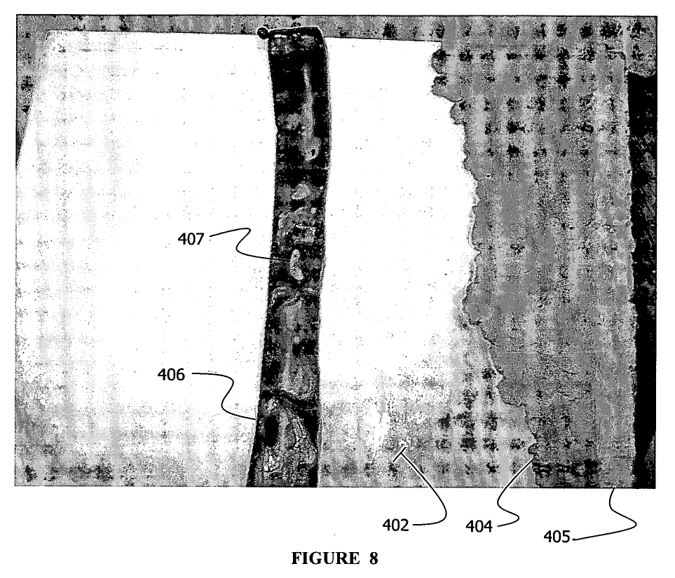

FIG. 8 illustrates the preparation of a cloth portion 406 for adherence to a work according to some embodiments of the present invention. A section of modeling compound 404 has been applied to a substrate with a first adhesive layer 402. A second adhesive layer 405 has been applied to a portion of the top surface of the modeling compound 404 in an area where a cloth strip 406 is intended to be adhered. The cloth strip 406 has also been coated with an adhesive 407 in the region of intended contact with the substrate 404.

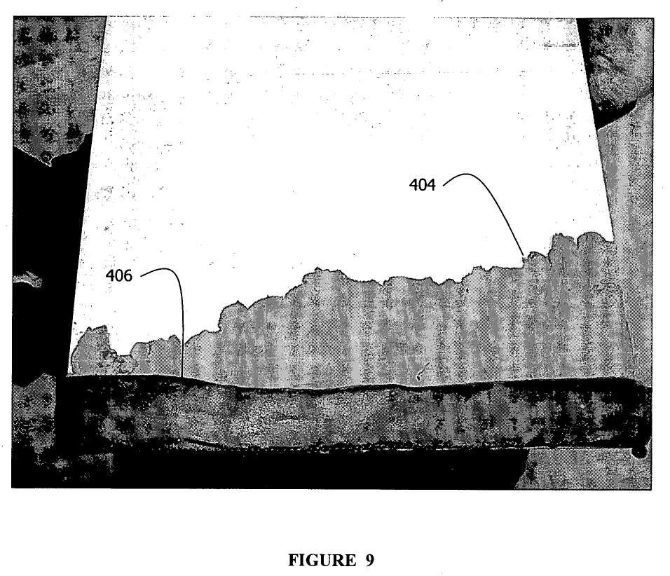

FIG. 9 illustrates the cloth strip 406 after the cloth strip has been added onto the modeling compound 404. The cloth strip 406 will be well adhered to the modeling compound 404 after the drying of the modeling compound and the adhesive. Although a cloth strip is used in this illustrative example, a wide variety of material may be used. The modeling compound according some embodiments of the present invention allows for the creation of works using a clay based compound that becomes very hard without firing, and that allows the use of a substrate that is not capable of withstanding intense heat, and the use of layers that are also not able to withstand intense heat. Paper and cloth that has been added onto and adhered to the modeling compound in the creation of a work may be covered with a mixture of one part white glue to two parts water. The works made according to these processes may be finished with a matte, satin, or gloss varnish that is suitable for acrylic works.

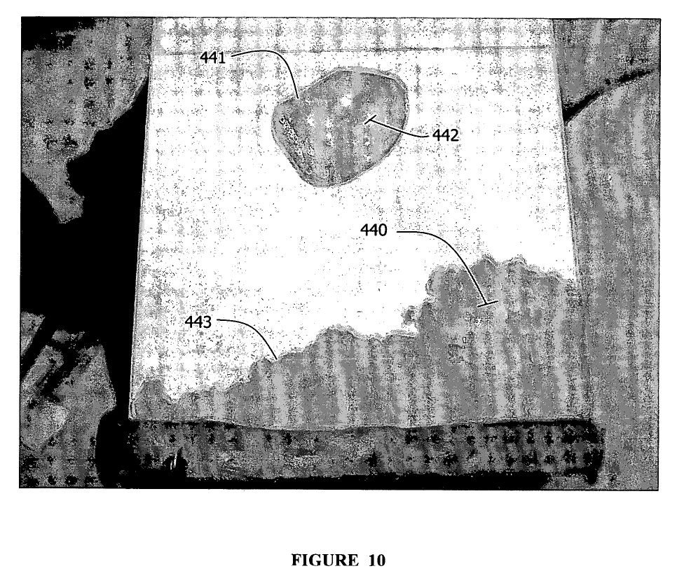

FIG. 10 illustrates the addition of more objects to the work using modeling compound according to some embodiments of the present invention. A piece of paper 441 is covered with adhesive 442. The modeling compound 443 has had an area on its surface covered with adhesive 440. As seen if FIG. 10, the paper 441 has been adhered to the modeling compound 443. With the use of the modeling compound according to some embodiments of the present invention, non-heat resistant items, such as paper 441, and photographs and the like, may be layered onto the artwork. The resulting work will dry to a very hard hardness without firing, allowing for the use of such items in a clay based work in a manner not previously available.

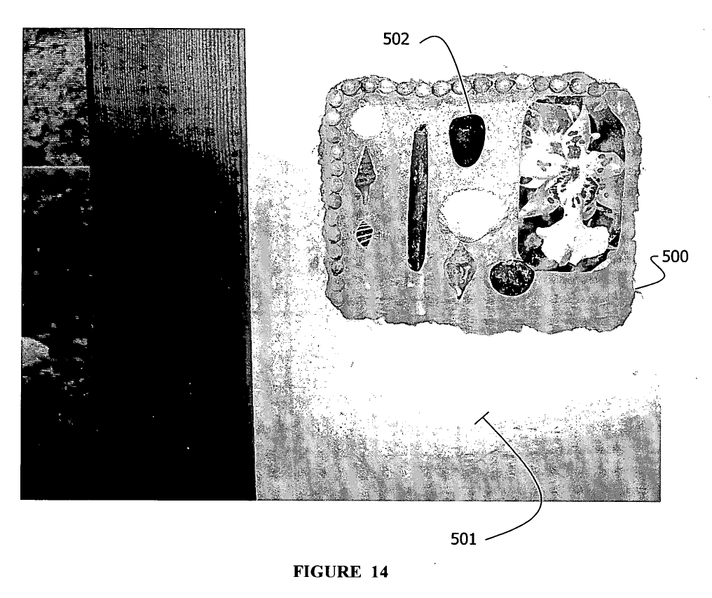

FIG. 14 illustrates the creation of a work on a wall using modeling compound according to some embodiments of the present invention. A work 500 is seen on a wall 501. The wall 501 may be a sheetrock wall in some embodiments. The wall 501 may be a plaster wall in some embodiments. The work 500 has been created in place on the wall 501 according to the process steps illustrated previously with other substrates. A variety of objects 502 are seen embedded in the work 500.

Straw bale construction is a type of home construction. Typically, the bale walls are finished using lime plaster, stucco, or earth plaster. Modeling compounds according to embodiments of this invention may be used to finish the bale walls of such a house. Modeling compounds according to embodiments of this invention are exceptionally easy to apply, and have more versatile application abilities relative to other straw bale finishing options.

Cob construction is another type of home construction. “Loaves” are made out of straw and earth to form walls. Modeling compounds according to some embodiments of the present invention can provide architectural and art accents to cob buildings, as well as a finishing material for the walls.

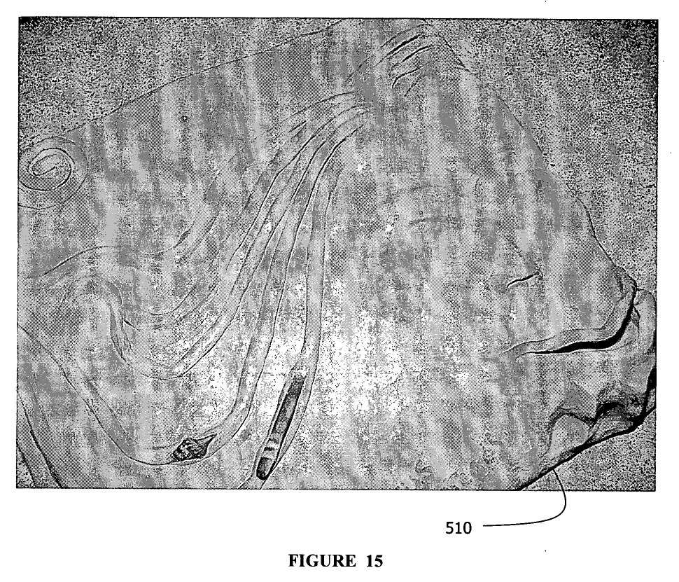

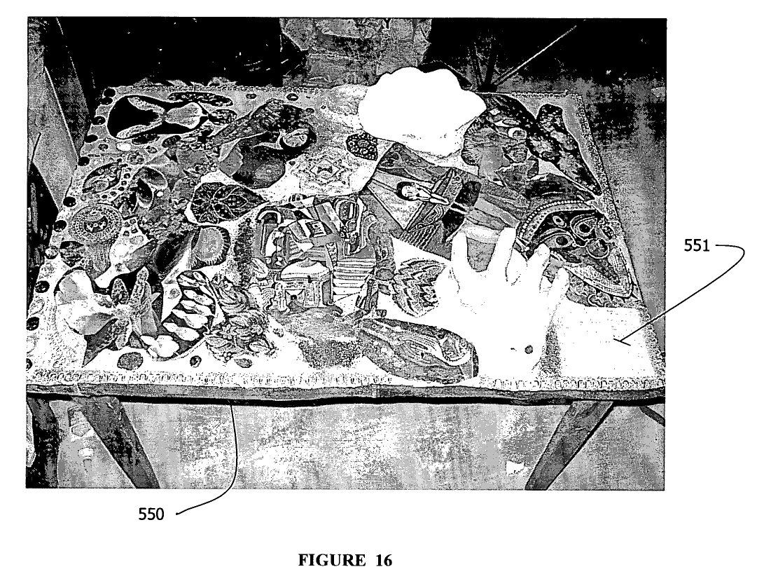

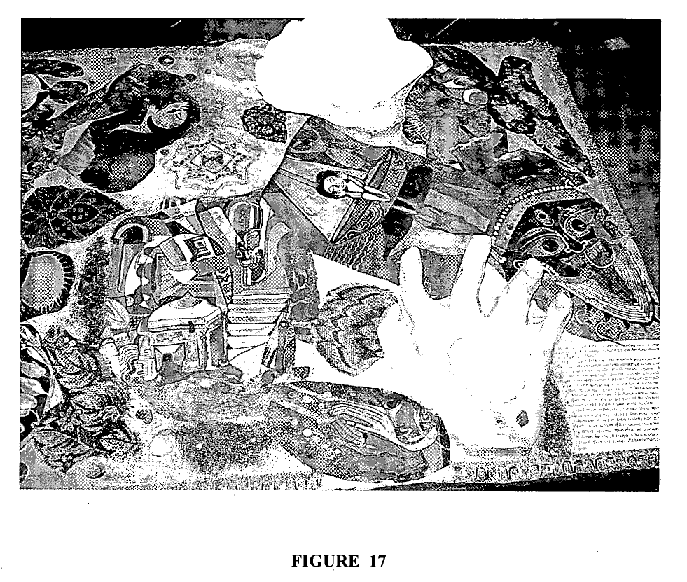

FIG. 15 illustrates an artwork 510 created on a canvas substrate according to some embodiments of the present invention. FIGS. 16-17 illustrate an artwork created on a table according to some embodiments of the present invention, including a sculpted hand, and a large embedded shell as part of the artwork. As seen in FIG. 16, a work 551 has been created on a table 550.

As evident from the above description, a wide variety of embodiments may be configured from the description given herein and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general invention.

I claim:

1. A material comprising:
clay;
pulp;
wallpaper paste; and
water.

2. The material of claim 1 wherein said wallpaper paste comprises wheat wallpaper paste.

3. The material of claim 2 wherein said pulp comprises paper pulp.

4. The material of claim 3 further comprising a non-toxic preservative.

5. The material of claim 2 wherein said pulp comprises rice.

6. The material of claim 2 wherein said pulp comprises hemp.

7. The material of claim 2 wherein said pulp comprises plant-based fiber.

8. A method for the creation of an artwork comprising:
covering all or part of a substrate with an adhesive; and
adhering modeling compound to the adhesive covered part of said substrate, wherein said modeling compound comprising:
clay;
pulp;
wallpaper paste; and
water.

9. The method of claim 8 wherein said pulp comprises paper pulp.

10. The method of claim 8 wherein said substrate comprises wood.

11. The method of claim 8 wherein said substrate comprises canvas.

12. The method of claim 8 further comprising painting said modeling compound.

13. The method of claim 8 further comprising adhering objects to said modeling compound.

14. The method of claim 13 wherein adhering objects to said modeling compound comprises:
covering the area where the object is to be adhered with adhesive; and
pressing said object into the adhesive covered area.

15. The method of claim 8 wherein said adhesive includes white glue.

16. A method for the creation of an artwork on a wall comprising:
covering all or part of a wall with an adhesive; and
adhering modeling compound to the adhesive covered part of said wall, wherein said modeling compound comprising:
clay;
pulp;
wallpaper paste; and
water.

17. The method of claim 16 further comprising adhering objects to said modeling compound.

18. The method of claim 17 wherein adhering objects to said modeling compound comprises:
covering the area where the object is to be adhered with adhesive; and
pressing said object into the adhesive covered area.

19. An artwork comprising:
a substrate; and
modeling compound adhered to said substrate, said modeling compound comprising:
clay;
pulp;
wallpaper paste; and
water.

20. The artwork of claim 19 wherein said pulp comprises paper pulp.

21. A method for the interior finishing of a wall comprising:
covering all or part of a wall with an adhesive; and
adhering modeling compound to the adhesive covered part of said wall, wherein said modeling compound comprising:
clay;
pulp;
wallpaper paste; and
water.

22. The method of claim 21 wherein said wall comprises a straw bale wall.

23. The method of claim 21 wherein said wall comprises a cob wall.
